(19) United States
(12) Patent Application Publication
(10) Pub. No.: US 2026/0037240 A1
(43) Pub. Date: Feb. 5, 2026

(54) PARSING DEPENDENCIES IN A CODEBASE

(71) Applicant: Cisco Technology, Inc., San Jose, CA (US)

(72) Inventor: Bhanu Pratap KARUMURI, San Jose, CA (US)

(21) Appl. No.: 19/281,334

(22) Filed: Jul. 25, 2025

Related U.S. Application Data
(60) Provisional application No. 63/677,552, filed on Jul. 31, 2024.

(51) Int. Cl. G06F 8/41

(52) U.S. Cl. CPC G06F 8/433; G06F 8/427

(57) ABSTRACT

Embodiments are directed to an automated identification and analysis of dependencies in a codebase. In particular, dependency graphs are automatically generated to represent the dependencies in a format that may be used to generate dependency-based output. Dependency-based output may include any type of output that indicates or represents data or analysis associated with dependencies in a codebase. In some cases, a dependency graph may be used to generate a representation or indication of dependency data or analysis. For example, a dependency matrix may be generated using a dependency graph and provided as output to represent various dependency data.

### CROSS-REFERENCE TO RELATED APPLICATIONS

This application claims benefit of Provisional U.S. Patent Application No. 63/677,552 filed Jul. 31, 2024, the entire contents of which are incorporated by reference herein in their entirety.

### BACKGROUND

Computing technologies are generally becoming more modernized and efficient. Accordingly, software developers may desire to leverage new computing technologies in existing code bases to modernize or keep pace with other industry leaders. For example, developers may desire to migrate a codebase to use a new platform or upgrade to new versions of code libraries or packages. In such migration scenarios, determining dependencies within the codebase is valuable to effectively perform the migration. For instance, understanding the integration of dependencies can help developers identify which components need to be updated, modified, or replaced during the migration process. Additionally, software developers may desire to monitor existing code bases for various reasons, such as redundancies. Redundant code files can put a strain on computing resources and cause additional security risks. As such, identifying and removing unused files through dependency analysis facilitates performance optimization and security risk minimization. Monitoring and identifying dependencies within a codebase, however, is ofttimes a time consuming and computing resource intensive process.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Embodiments described herein are directed to an automated identification and analysis of dependencies in a codebase. In this way, dependencies may be identified and analyzed in an effective and efficient manner. In particular, dependency graphs are automatically generated to represent the dependencies in a format that may be used to generate dependency-based output. Dependency-based output may include any type of output that indicates or represents data or analysis associated with dependencies in a codebase. In some cases, a dependency graph may be used to generate a representation or indication of dependency data or analysis. For example, a dependency matrix may be generated using a dependency graph and provided as output to represent various dependency data.

### BRIEF DESCRIPTION OF THE DRAWINGS

Illustrative examples are described in detail below with reference to the following figures:

FIG. 1 is a block diagram of an embodiment of a dependency analysis environment. FIG. 2 illustrates example code files, in accordance with embodiments of the

present technology.

FIG. 3 illustrates an example abstract syntax tree representing a code file, in accordance with embodiments of the present technology.

FIG. 4A is an example representation of a dependency graph, in accordance with embodiments of the present technology.

FIG. 4B is an example of a dependency graph in an object structure, in accordance with embodiments of the present technology.

FIG. 5 illustrates an example dependency matrix, in accordance with embodiments of the present technology.

FIG. 6 illustrates a flow diagram of an example process for analyzing codebase dependencies, in accordance with embodiments of the present technology.

### DETAILED DESCRIPTION

Computing technologies are constantly evolving, becoming more modernized and efficient. Accordingly, software developers may desire to leverage new computing technologies in existing code bases to modernize or keep pace with other industry leaders. For example, developers may desire to migrate a codebase to use a new platform or upgrade to new versions of code libraries or packages. In such migration scenarios, determining dependencies within the codebase is valuable to effectively perform the migration. For instance, understanding the integration of dependencies can help developers identify which components need to be updated, modified, or replaced during the migration process. As a result, such an understanding of dependencies can facilitate more efficient planning, reduce the risk of breaking existing functionality, and ensure a smoother transition to a new platform or updated library.

Additionally, software developers may desire to monitor existing code bases for redundancies generated over time, for example, due to updates or other restructuring. Redundant code files can put a strain on computing resources and cause additional security risks. For example, even if such files are no longer actively used, the files are often still processed by build systems, static analysis tools, and test suites, thereby resulting in longer build times, increased memory and CPU usage, etc. Further, unused code may contain outdated libraries, insecure logic, or hardcoded credentials that may result in a security liability. For instance, because such code is maintained in a codebase, it may be invoked unintentionally or exploited by an attacker. As such, identifying and removing unused files through dependency analysis facilitates performance optimization and security risk minimization.

As such, identifying code dependencies is crucial for effective and efficient monitoring and modernization of code. For instance, identifying code dependencies facilitates understanding how different parts of a codebase are connected, thereby making it easier to isolate and update outdated components without causing unintended impacts. Such an understanding also accelerates migrations, reduces downtime, and ensures that monitoring and modernization focuses on more critical and actively used code.

Effectively and efficiently identifying code dependencies, however, can be a challenging task as developers may have to analyze hundreds or thousands of code files to determine dependencies between code files before moving, modifying, or deleting a particular code file. In this way, a large-scale analysis can be tedious and error-prone and, as such, increases the risk of missing subtle or indirect dependencies, which impacts accuracy and may lead to bugs during code changes.

For example, in conventional implementations, identifying dependencies within a codebase is based on manual inspection and analysis by developers. Such a process generally includes reviewing import statements, function calls, and variable references across multiple files to trace dependencies. Some developers used basic text search tools or integrated development environment (IDE) features to assist in finding references and usages, and version control systems include some insight into file relationships through commit history. However, such implementations are time-consuming, error-prone, and are increasingly challenging as codebases grow in size and complexity. Additionally, visualizing and managing the identified dependencies remains a largely manual and cognitively demanding task, making it difficult for developers to gain a holistic understanding of the codebase structure and interdependencies.

Further, scanning and processing such an extensive number of files consumes significant computing resources, such as CPU, memory and storage, particularly when performed repeatedly in automated build and test pipelines. For instance, an exhaustive analysis requires substantial CPU cycles to parse and analyze data, memory to hold intermediate representations, and disk I/O to read the entire codebase, particularly in large-scale systems. Such a process not only delays feedback to developers, but also increases operational costs in cloud or on-premise environments.

Accordingly, the present technology is directed to an automated identification and analysis of dependencies in a codebase. In this way, dependencies may be identified and analyzed in an effective and efficient manner. In particular, dependency graphs are automatically generated to represent the dependencies in a format that may be used to generate dependency-based output. Dependency-based output may include any type of output that indicates or represents data or analysis associated with dependencies in a codebase. In some cases, a dependency-based output may be in the form of a dependency graph. In other cases, a dependency graph may be used to generate another form of a representation or indication of dependency data or analysis. For example, a dependency matrix may be generated using a dependency graph and provided as output to represent various dependency data.

Accordingly, embodiments described herein enable detecting, graphing, and visualizing file dependencies in a codebase in an efficient and effective manner. Using implementations described herein, developers may be provided with information related to dependencies in a code base ahead of a planned migration, thereby enabling a developer or program to make informed decisions in a migration planning process. Additionally, identification of dependencies enable developers to remove unused code files without presenting issues that removal may cause, such as dependency errors in other parts of the codebase. As such, efficient and effective identification of dependencies in codebase and provide data associated therewith provides for more efficient systems, for example, by decreasing the number of files executed at runtime.

In operation, and at a high level, a dependency analysis system may provide an automated approach for identifying, mapping, and visualizing dependencies within a codebase. In some implementations, code files may be parsed to identify dependencies. Such identified dependencies may then be used to generate a comprehensive dependency graph. Thereafter, various forms of dependency-based output may be produced or generated. For example, a dependency matrix may be generated, using the dependency graph, to represent various dependency data. In accordance with performing such an automated process, developers may gain a holistic understanding of the codebase structure and interdependencies, which may be particularly valuable in large-scale software projects.

Advantageously, the dependency identification and analysis implementations described herein may provide a significant reduction in the time and effort required to identify and analyze dependencies. Further, the automated nature and implementations described herein also improve accuracy and consistency in dependency identification, reducing the risk of overlooked or misinterpreted dependencies. Additionally, generating visual representations of dependencies in an automated and efficient manner may enhance developers' understanding of the codebase structure, potentially leading to more informed decision-making in code migration, refactoring, and optimization efforts.

As can be appreciated, accurate identification of dependencies within a codebase enables a reduction of computer resource utilization. For example, in cases in which dependencies are accurately identified in an automated manner, computer resources are not unnecessarily used to identify dependencies in a manual manner and to repetitively perform such a process to achieve accurate identification. In addition, computer resources are not unnecessarily used to manually generate visualizations of such dependency data. Automated generation of visualizations reduces the need for repeated rendering, manual scripting, and ad hoc data extraction, thereby optimizing compute time, memory usage, and developer effort. Further, by monitoring and/or migrating codebase using accurate identification and analysis of dependencies, computer resource utilization is reduced by accurately removing unused code, thereby reducing the use of computing resources that would otherwise be spent managing, analyzing, and/or processing such unused code.

### DEPENDENCY ANALYSIS SYSTEM

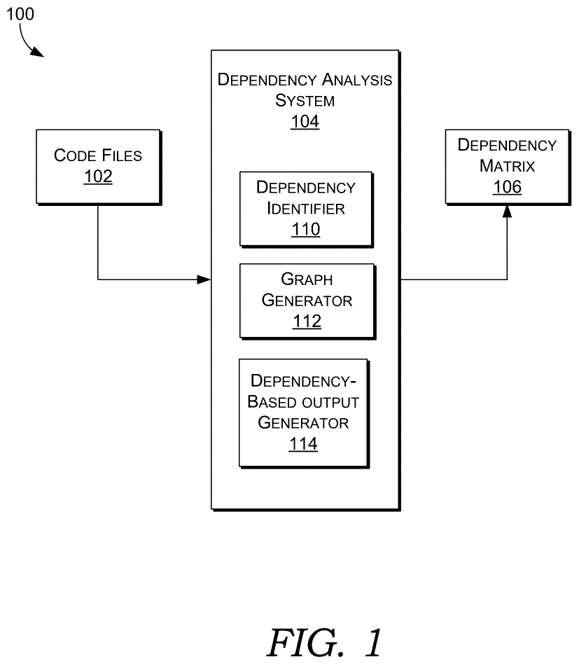

FIG. 1 provides an example of a block diagram of a dependency analysis environment 100, in accordance with embodiments described herein. The dependency analysis environment 100 may be configured to analyze and process codebases to identify, map, and/or visualize dependencies between different code files and components in an automated and effective manner. In some implementations, the dependency analysis environment may handle large-scale codebases, potentially comprising thousands of files across multiple programming languages. At a high-level, the dependency analysis environment 100 enables parsing various file types, extracting relevant information about dependencies, and generating dependency-based output, such as comprehensive reports and visualizations, which may be used to understand structure of a codebase.

In the illustrated embodiment, the dependency analysis environment 100 includes code files 102 and a dependency analysis system 104, which processes the code files 102 and generates a dependency-based output, such as a dependency matrix 106. In this way, the dependency analysis environment 100 obtains one or more code files. Such code files may be obtained, for example, from a data source and/or a data store. The code files 102 may include any number of code files and may vary in size and complexity, ranging from small utility scripts to large, complex modules with intricate dependency structures.

Code files 102 may represent different components of a software application, including but not limited to source code, configuration files, build scripts, and documentation. The code files 102 may include code of any of a variety of programming languages capable of supporting file dependencies, such as Java, C++, Python, JavaScript, or domain-specific languages, reflecting the diverse nature of modern software projects. Other examples of code files include markup languages (HTML, XML), stylesheets (CSS), data serialization formats (JSON, YAML), and domain-specific configuration files. One example of code files 102 is further described below in reference to FIG. 2.

In some implementations, the code files 102 analyzed by the dependency analysis environment 100 may originate from various sources within a software development ecosystem. For example, code files may reside in version control systems like Git, Subversion, or Mercurial, allowing the dependency analysis system 104 to access different versions and branches of the codebase. In some cases, the system may analyze code files from multiple repositories or microservices that collectively form a larger application ecosystem.

The code files 102 may include proprietary code developed in-house and/or third-party libraries or frameworks (e.g., integrated into a project). Code files may encompass various architectural layers of an application, such as frontend user interfaces, backend services, data access layers, and utility modules. In some implementations, code files 102 may include generated code, such as code produced by code generators, to ensure a comprehensive analysis of the entire codebase.

In some aspects, the code files may represent different stages of the software development lifecycle, including production code, test code, and experimental features. This diverse set of code files allows the dependency analysis system to provide a holistic view of the project's structure and dependencies across various components and development phases.

In accordance with obtaining code files 102, the dependency analysis system 104 may analyze the code files to identify dependencies and, thereafter, perform analysis and/or generate data associated therewith. The dependency analysis system 104 may be implemented using one or more computing devices and can include compute resources (e.g., processors, volatile/non-volatile memory, non-volatile data stores, etc.) and/or one or more data stores. In some cases, the dependency analysis system 104 may be implemented on a host system in a shared computing resource environment, such as a virtual machine, software container, or other isolated execution environment, etc. It should be understood that this and other arrangements of components illustrated and described herein are set forth as examples. Other arrangements and elements (for example, machines, interfaces, functions, orders, and groupings of functions, etc.) can be used in addition to or instead of those shown, and some elements can be omitted altogether. Further, many of the elements or components described herein are functional entities that can be implemented as discrete or distributed components or in conjunction with other components, and in any suitable combination and location. Various functions described herein as being performed by one or more entities can be carried out by hardware, firmware, and/or software. For instance, various functions can be carried out by a processor executing instructions stored in memory such as a non-transitory computer-readable medium.

At a high level, the dependency analysis system 104 may be configured to analyze code files to identify and map file dependencies, as further described herein. In this regard, a multi-step process may be implemented to identify and analyze dependencies, as well as generate dependency-based output, such as reports or visualizations associated with dependencies within a codebase.

As shown in in FIG. 1, one example of a dependency analysis system 104 includes a dependency identifier 110, a graph generator 112, and a dependency-based output generator 114. It should be understood that any number of user devices and servers may be employed within the dependency analysis environment 100 and are within the scope of the present technology. Each device or server may comprise a single device or multiple devices cooperating in a distributed environment. For instance, the dependency analysis system 104 can be provided by multiple server devices collectively providing the functionality of that system, as described herein. Additionally, other components not shown may also be included within the system illustrated in dependency analysis environment 100.

The dependency identifier 110 is generally configured to identify dependencies in a codebase. To do so, in some implementations, the dependency identifier 110 may parse the code files 102 to identify dependencies between different components. The dependency identifier 110 may employ various techniques to accomplish this task. For example, the dependency identifier 110 may utilize abstract syntax tree (AST) parsing to analyze the structure of each code file and extract information about import statements, function calls, and variable references. An AST may refer to a tree-like representation of a structure of code, where each node represents a construct (e.g., a variable, a function call, a loop, etc.). Instead of raw text, the AST captures the semantic structure of the code in a format that is easier to programmatically analyze.

The dependency identifier 110 may analyze the code files, or parsed code files (e.g., an AST) to identify dependencies. For example, an AST representing code files may be traversed to identify dependencies associated therewith. In embodiments, the dependency identifier 110 may identify explicit dependencies and/or implicit dependencies. Explicit dependencies typically refer to dependencies directly declared in the code. For example, the dependency identifier 110 may scan for explicit dependencies by examining import statements or include directives within each file. These explicit dependencies are typically straightforward to identify as they are directly declared in the code. Implicit dependencies typically are not directly declared in the code, but rather exist as code components may depend on each other's behavior, data, or definitions. Implicit dependencies may include function calls, variable usage, shared state or global data, assumed context or side effects, etc. To identify implicit dependencies, the dependency identifier 110 may perform a more in-depth analysis of the code, such as performing tracing function calls across different files, analyzing variable usage patterns, and examining data flow between components. In some cases, the dependency identifier 110 may employ heuristic algorithms to infer implicit dependencies. Such algorithms may consider factors such as naming conventions, file organization, and common coding patterns to make educated guesses about potential dependencies.

Identified dependencies may be represented in any of a number of ways. For instance, a set of dependency records or data structures may be generated that indicate relationships within a codebase. As one example, a dependency record or data structure may include a source (e.g., a file, module, function, class, etc. that contains the dependency), an outgoing dependency, (e.g., a file, class, function, etc. being depended upon), an incoming dependency (e.g., what depends on a file, module, etc.), and/or a type of dependency (e.g., explicit import, implicit function call, or variable usage). In some cases, such records or data structures may include metadata, such as a location (e.g., the specific line numbers) associated with dependencies, a dependency category, relevant contextual information, source language, etc. In some cases, such directory records or data structures may be in structured record, such as tuples or JSON, a table, etc.

In accordance with identifying dependencies, the graph generator 112 may use identified dependencies to generate a dependency graph. In this regard, the graph generator 110 may generate a dependency graph that represents relationships between various code files and modules. A dependency graph generally refers to a graph (e.g., directed graph) that visually and/or structurally represents relationships where one element depends on another. In embodiments, the nodes, or vertices, may represent entities, such as files, modules, classes, functions, or components. The edges, or directed arrows, may represent dependencies. For example, an edge from node A to node B means A depends on B.

As described, the graph generator 112 may utilize the identified dependencies (e.g., as represented via dependency records) provided by the dependency identifier 110 to construct a comprehensive dependency graph. In embodiments, the graph generator 112 may employ algorithms to process the identified dependencies and create a structured representation of the relationships between various code files and modules within the codebase.

In some implementations, when generating a dependency graph, the graph generator 112 may create nodes representing each unique code file or module in the codebase, or portion thereof. Thereafter, edges between these nodes may be established based on the identified dependencies. In some cases, the graph generator 112 may assign weights or attributes to these edges to represent the strength or nature of the dependencies.

The graph generator 112 may also consider transitive dependencies that exist across multiple levels of the codebase. For instance, if file A depends on file B, and file B depends on file C, the graph generator 112 may infer an indirect dependency between file A and file C. This transitive dependency analysis may help developers understand the full impact of changes to a particular file or module.

In some implementations, the graph generator 112 may use clustering algorithms to group closely related files or modules together in the graph. Such clustering may help visualize the overall structure of the codebase and identify tightly coupled components.

The resulting dependency graph may be stored in a suitable data structure. Advantageously, the generated dependency graph may may be used for various dependency-based analyses and may be used by other components of the system, such as the dependency-based output generator 114, to create visual representations or reports of the codebase structure.

The dependency-based output generator 114 is generally configured to generate dependency-based output. In this regard, the dependency-based output generator 114 is responsible for producing various forms of analysis and representations based on the dependency information gathered by the system. Dependency-based output refers to any output or analysis results associated with dependencies in codebase. For example, dependency-based output can be any information, visualization, or report derived from the analysis of dependencies within a codebase. Such dependency-based output may be used to provide, among other things, insights into the structure, relationships, and potential issues within the codebase.

As one example, the dependency-based output generator 114 may generate a dependency matrix, such as dependency matrix 106. A dependency matrix may refer to a tabular representation of the relationships between different components of a codebase. To generate a dependency matrix, the dependency-based output generator 114 may iterate through the nodes of the dependency graph, creating rows and columns corresponding to each file or module. The cells of the matrix may then be populated with indicators of dependency relationships, such as binary values (0 or 1) or more detailed information about the nature of the dependency. Such a matrix format can allow developers to quickly identify which components are most interconnected or isolated within the codebase. In some cases, a dependency matrix may be predefined or a default structure. In other cases, a dependency matrix may be dynamically structured (e.g., based on the identified dependencies, based on an input user request, etc.).

Additionally or alternatively, the dependency-based output generator 114 may produce visualizations of a dependency graph. Such visualizations can take various forms, such as node-link diagrams, force-directed graphs, or hierarchical tree structures. In some implementations, the system may generate interactive visualizations that allow developers to explore the codebase structure dynamically. For example, developers may be able to zoom in on specific parts of the graph, highlight particular dependency paths, or filter the view based on certain criteria.

In addition to matrices and visualizations, the dependency-based output generator 114 may apply various analyses to the dependency graph to provide a report (e.g., a comprehensive report). Such a report may offer insights into different aspects of the codebase structure and dependencies. For instance, the dependency-based output generator 114 may perform impact analysis to identify which parts of the codebase might be affected by changes to a particular file or module. This information can be crucial for planning refactoring efforts or assessing the potential consequences of code modifications.

In some implementations, the dependency-based output generator 114 may offer customizable reporting options. For example, a user may request, via a user interface, an analysis to identify unused dependencies that could potentially be removed from the codebase. The dependency-based output generator 114 may then traverse the dependency graph, identify components with no incoming dependencies or those that are not reachable from entry points, and generate a report listing these unused elements.

The format and content of the reports generated by the dependency-based output generator 114 may vary. In some cases, the dependency-based output generator 114 may provide reports in a default or predetermined format, offering a standard set of metrics and insights. In other cases, the dependency-based output generator 114 may allow for user input to customize the report content and format. For instance, a user may be able to specify a particular area of interest, choose specific metrics to include, or select from different visualization options.

In some implementations, the dependency-based output generator 114 may leverage artificial intelligence (AI) techniques to enhance its reporting capabilities. AI algorithms may be employed to analyze patterns in the dependency graph, identify potential code issues or architectural issues, and/or generate natural language summaries of the codebase structure. AI-driven insights may help developers quickly grasp complex dependency relationships and make informed decisions about code organization and refactoring.

In some cases, the dependency-based output generator 114 may offer predictive analysis capabilities. By analyzing the current dependency structure and historical trends, the dependency-based output generator 114 may be able to forecast potential future issues, such as areas of the codebase that are likely to become overly complex or tightly coupled. This predictive insight may help development teams proactively address architectural concerns before they become significant problems.

The dependency-based output may be provided for display to a user. For example, the dependency-based output may be provided to a user device for display to a user, such a user requested to perform dependency analysis. Such dependency-based output may additionally or alternatively be stored in a data store, for example, for subsequent access, analysis, presentation, etc.

In some cases, the dependency-based output may be integrated with other development tools and processes. For example, generated reports and visualizations may be incorporated into continuous integration pipelines, providing automated dependency analysis as part of the build process. This integration may allow teams to monitor dependency-related metrics over time and set up alerts for significant changes or potential issues.

Further, in accordance with the generated dependency-based output, in some cases, an action may be automatically initiated and/or performed that accounts for the dependency-based output. For example, assume unused code is identified. In such a case, the unused code may be automatically removed from the codebase. In some cases, the unused code may be removed based on approval or confirmation from a developer or user. For instance, a notification may be provided to indicate the unused code to remove and, based on a confirmation by a user, the unused code is automatically removed.

### DEPENDENCY IDENTIFICATION

FIG. 2 illustrates example code files 200A-200G (herein referred to as code files 200). In some implementations, the code files 200 may be all or a portion of a larger codebase. The code files 200 may be expressed in any programming languages that allows file dependencies (e.g., C++, C #, java, javaScript, etc.). Each code file can comprise 0 or more import statements 202, such as import statements 202A, 202B, or 202C. In some implementations, an import statement 202 can enable a code file 200 to utilize functionality from another code file as identified in the import statement.

For example, as illustrated, the code file 200A comprises function 204A, entitled “sumMultipleSets,” which provides functionality to add multiple sets of numbers together. The code file 200B comprises a function 204B204, entitled “sumSet,” which provides functionality to add a set of numbers together. The code file 200C comprises a function 204C, entitled “getSets,” which returns a plurality of sets of numbers. And the code file 200D comprises a function 204D, entitled “add,” which adds two numbers together. The code file 200B comprises an import statement 202C that references code file 200D. The code file 200A comprises import statements 202A and 202B that reference code files 200B and 200C, respectively. This enables code file 200A to call the function 204C, utilize the results of the function 204C to call the function 204. Because the code file 200B imports code file 200D, the function 204B can call function 204D and return the results to function 204A. Consequently, to function properly, the code file 200A relies on the functions 204B and 204C from code files 200B and 200C, respectively. Accordingly, code file 200A can be said to depend on code files 200B and 200C. Additionally, code file 200B can be said to depend on the code file 200D.

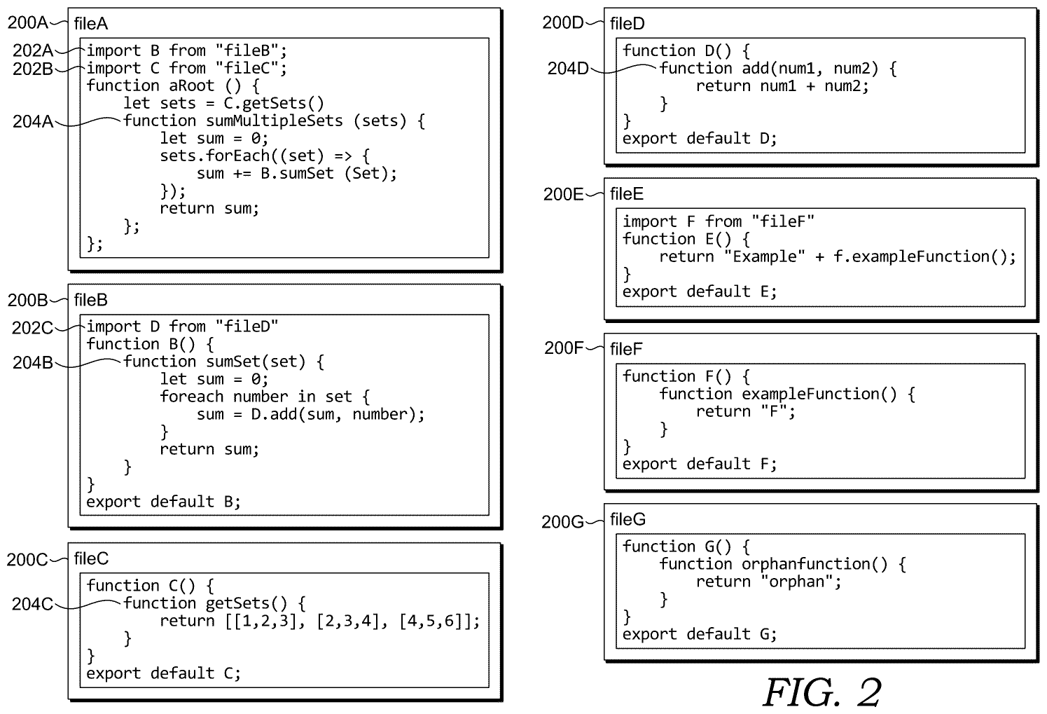

FIG. 3 illustrates an example abstract syntax tree 300 representing the code file 200A. In some implementations, an abstract syntax tree can represent the structure of a code file. An abstract syntax tree may be expressed in a variety of data or file formats, such as java script object notation (JSON). For example, in the illustrated example, elements of the code file 200A are expressed as components of the “program” object 302. As illustrated, the import statement 202A is expressed as component 304, having a type of “import declaration” and a value comprising the file name of “fileB,” which corresponds to the code file 200B. Additionally, the import statements 202B is expressed as component 306, having a type of “import declaration” and a value comprising the file name of “fileC,” which corresponds to the code file 200C.

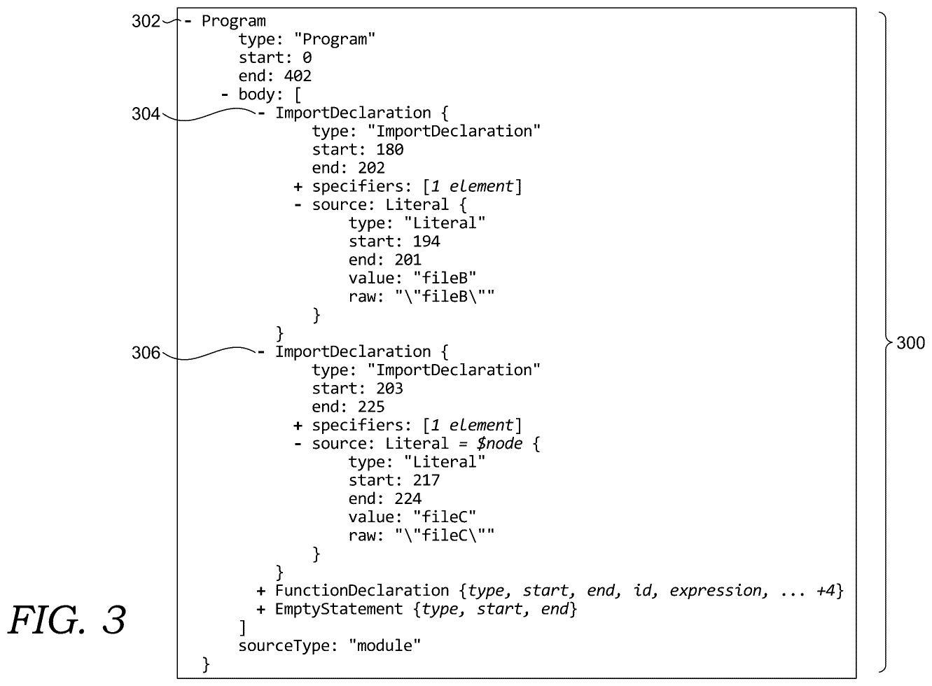

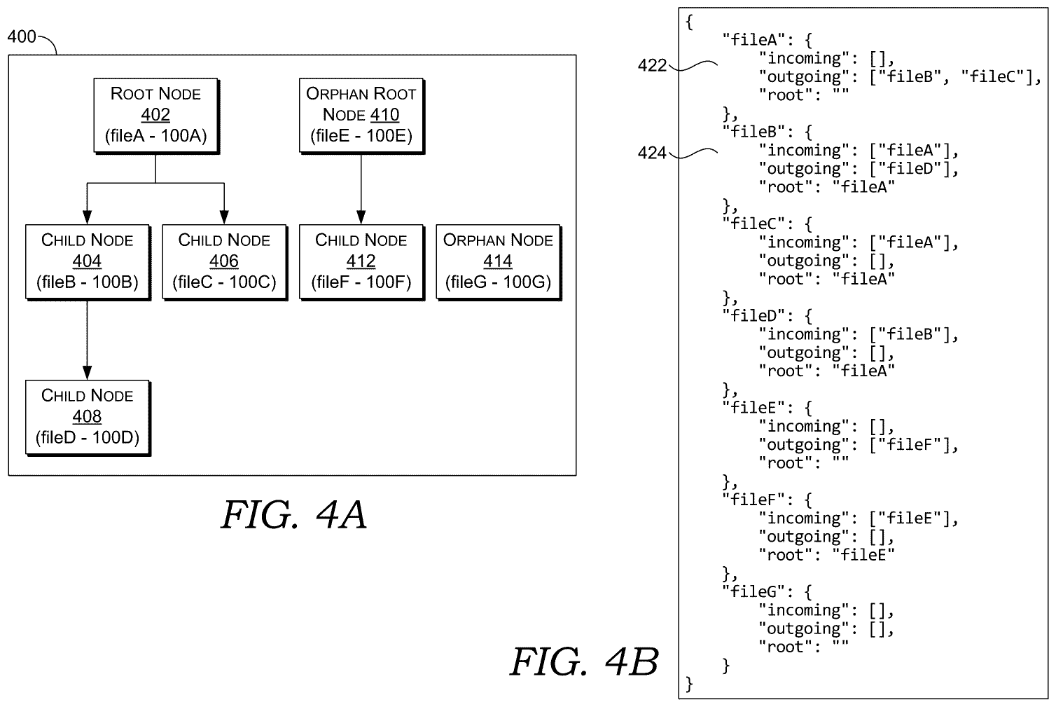

In some implementations, a third-party abstract syntax tree generator, such as AST Explorer, may be used to generate an abstract syntax tree based on one or more code files. In some implementations, the abstract syntax tree 300 may be parsed to identify the components 304 and 306 corresponding to the import statements 202. For example, the system can parse the abstract syntax tree 300 based on component identifier, wherein import statements 202 may be identified by an identifier such as “ImportDeclaration” or “ImportStatement.” The system can accordingly identify the files referenced by the import statements 202 as outgoing dependencies, meaning that the code file being analyzed (in the illustrated example, the code file 200A) depends on the referenced files. In some implementations, the system can parse a plurality of code files, such as the code files 200 to generate a graph of file dependencies, such as that described herein with reference to FIGS. 4A and 4B.

### GENERATE DEPENDENCY GRAPH GENERATION

FIG. 4A is an example representation of a dependency graph 400 based on the code files 200. As described above, with reference to FIGS. 1 and 2, the system can parse each code file 200 to identify any import statements 202 and identify corresponding file dependencies. Based on the identified dependencies, the system can generate a graph structure mapping incoming and outgoing dependencies of each file. Incoming dependencies can correspond to those code files depending on a particular code file, and outgoing dependencies can correspond to those code files that a particular code file depends on. For example, as illustrated, for the code file 200B, the code file 200A is an incoming dependency, and the code file 200D is an outgoing dependency.

In some implementations, the dependency graph 400 may comprise a tree or plurality of trees and/or subtrees. Each tree or subtree may comprise a plurality of nodes, with each tree comprising a root node from which all other nodes branch.

In some implementations, the system can correspond to a codebase for a front-end computing application. Accordingly, the codebase may comprise code files corresponding to different dashboards for display on a web browser or other graphical display. The codebase may also comprise code files corresponding to components or elements of a dashboard. In some implementations, the root node for each tree can correspond to a particular dashboard. For example, in some implementations, the system may be applied to a codebase corresponding to a plurality of webpages. Each webpage may utilize a number of code files to function. Accordingly, each webpage may serve as a root node for a tree or subtree of the dependency graph. In some implementations, a particular webpage may comprise a dashboard having a plurality of components. In such an implementation, the dependency graph 400 may comprise a tree associated with the dashboard, wherein the dashboard is represented as a root node and each component is represented as a sub-root node for its own subtree.

In the illustrated example, the dependency graph 400 comprises a tree with a root node 402 corresponding to the code file 200A, and a plurality of child nodes 404-408, along with orphan root node 410 and child node 412, and orphan node 414. The child node 404 corresponds to the code file 200B, and the child node 406 corresponds to the code file 200C. Child nodes 404 and 406 branch off from root node 402 because code file 200A depends on the code files 200B and 200C. Additionally, child node 408 corresponds to the code file 200D and branches off from the child node 404 because the code file 200B depends on the code file 200D.

In the illustrated example, the orphan root node 410 corresponds to the code file 200E. The orphan root node 410 has child node 412 that branches off from the orphan root node 410. The child node 412 corresponds to the code file 200F. In the illustrated example, the orphan root node 410 is classified as an orphan root node because it corresponds to a code file that is not associated with a dashboard or dashboard component but has a code file, code file 200F, that it depends on.

Finally, the orphan node 414 corresponds to the code file 200G. In the illustrated example, the orphan node 414 is classified as an orphan node because the corresponding code file 200G is not associated with a dashboard or dashboard component, does not have any dependencies, and does not have any files that depend on the code file 200G.

The system can represent the dependency graph 400 in an object structure, such as a JSON object, as illustrated in FIG. 4B. For example, as illustrated, each node represents a component of the object structure with each component comprising parameters that identify incoming dependencies, outgoing dependencies, and a root node. For example, component 422 corresponds to root node 402, which has no incoming dependencies, 2 outgoing dependencies, and is the root node, so a root node is not specified. Component 424 corresponds to child node 404 and has an incoming and outgoing dependency, and identifies its corresponding root node by name as “fileA.”

In some implementations, the system can use the dependency graph 400 to identify orphan code files, such as that corresponding to the orphan node 414, or orphan trees, such as the tree comprising the orphan root node 410 and its corresponding code files. An orphan node may refer to a node that doesn't have a dependency or is not being called within a tree. The system may then remove the orphan code files or code files that comprise an orphan tree from the codebase. This can improve system performance and efficiency. For instance, in some implementations, the system may be configured to fetch all dependencies of a codebase when loading a webpage, by identifying and removing orphan code files, the system can reduce page load time that would otherwise be extended by fetching unutilized code files at runtime. In some implementations, a user of the system may analyze the graph to detect orphan nodes or orphan trees and determine whether to retain or remove the corresponding files.

### DEPENDENCY MATRIX GENERATION

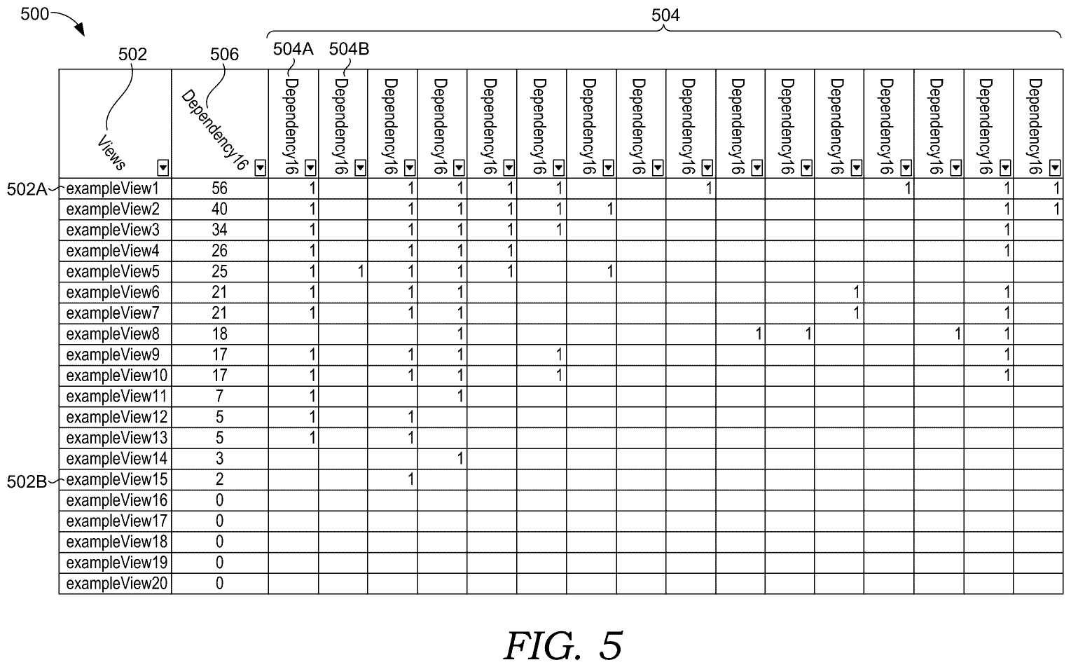

FIG. 5 illustrates an example dependency matrix 500. The dependency matrix can be based on a dependency graph, such as that described herein with reference to FIG. 4. In some implementations, such as where the codebase corresponds to a front-end computing application comprising a plurality of dashboards or webpages, the dependency matrix can comprise rows corresponding to different webpages, dashboards, or dashboard components.

For example, in the illustrated example, each row of the dependency matrix 500 corresponds to a different view 502. An individual view may correspond to a webpage, dashboard, or dashboard component. For example, view 502A corresponds to the “exampleView1” dashboard. In the illustrated example, a dependency count column 506 indicates how many dependencies correspond to each view. Additionally, the dependency matrix comprises a set of dependency file columns 504, wherein each of the dependency file columns 504 represents a different code file with an indicator of whether a particular view depends on that code file. For example, for view 502A, the dependency count column 506 indicates 56 as view 502A has 56 files it depends on. The individual dependencies are indicated by the set of dependency file columns 504. For example, the dependency file column 504A corresponds to the file entitled “Dependency1.” The dependency file column 504A includes a “1” for the row of view 502A to indicate that the view 502A depends on the “Dependency1” file.

### MIGRATION ROADMAP GENERATION

As described, in some implementations, a system user can utilize the dependency matrix 500 to generate a migration roadmap. For example, a system user may be planning to migrate the codebase from a set of legacy or outdated code files or packages to a more modern set of code files and packages. To facilitate a faster transition, the system may suggest or highlight files with fewer dependencies for migration first, such as the file associated with view 502B. A code file, such as that associated with view 502A, may have many dependencies and be more complex to migrate. In some cases, simple and complex files may have overlapping dependencies. For example, the view 502A has 56 dependencies, one of which is “Dependency3” associated with dependency file column 504B. The view 502B has 2 dependencies, one of which is also the file associated with dependency file column 504B. By migrating the file associated with view 502B first, the file associated with dependency file column 504B can be removed or replaced with an updated file at the time of migration of view 502B, such that it will already be handled by the time a system user migrates the more complex file associated with view 502A.

### PROCESS FOR ANALYZING CODEBASE DEPENDENCIES

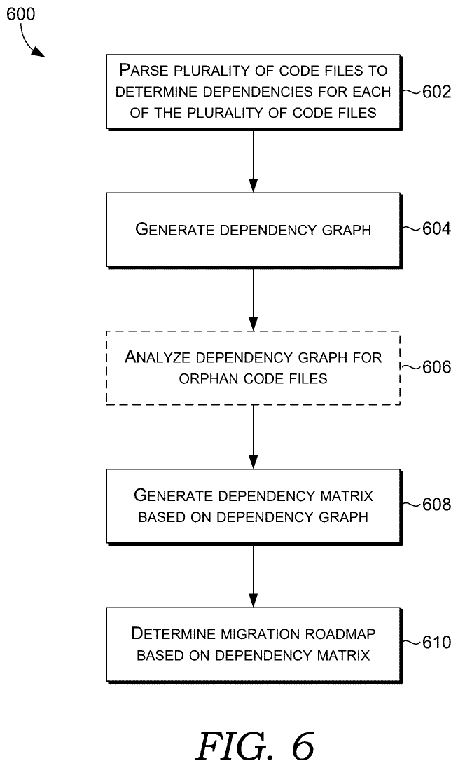

FIG. 6 illustrates a flow diagram of an example process 600 for analyzing codebase dependencies. Although steps are illustrated in a particular order, steps may be performed multiple times, the order of the steps may be changed, and/or one or more steps may be performed concurrently. Additionally, fewer, more, or different steps may be performed.

At block 602, the dependency analysis system 104 can parse a plurality of code files to determine dependencies for each of the plurality of code files. In some implementations, prior to parsing, the dependency analysis system 104 can identify the plurality of code files to parse. In some implementations, the plurality of code files may be obtained by scanning a file folder or file folder system. In some implementations, a list of the plurality of code files may be provided by a user of the system. In some implementations, the dependency analysis system 104 can parse the code files to determine dependencies, as described herein with reference to FIGS. 2 and 3.

At block 604, the dependency analysis system 104 can generate a dependency graph, such as that described herein with reference to FIGS. 4A and 4B. In some implementations, the dependency analysis system 104 can perform optional block 606 and analyze the dependency graph generated at block 604 to determine if any orphan code files exist, and remove them, as described herein with reference to FIGS. 4A and 4B.

At block 608, the dependency analysis system 104 can generate a dependency matrix based on the dependency graph generated at block 604. The dependency analysis system 104 can generate a dependency matrix, such as that described herein with reference to FIG. 5. At block 610, the dependency analysis system 104 can determine a migration roadmap based on the dependency matrix. For example, in some implementations the dependency analysis system 104 can produce a roadmap for which files to migrate in which order. In some implementations, the system may prioritize files with fewer dependencies over files with more dependencies. In some implementations, a user of the dependency analysis system 104 can determine the migration roadmap based on the dependency matrix generated at block 608.

### TERMINOLOGY

Computer programs typically comprise one or more instructions set at various times in various memory devices of a computing device, which, when read and executed by at least one processor, will cause a computing device to execute functions involving the disclosed techniques. In some cases, a carrier containing the aforementioned computer program product is provided. The carrier is one of an electronic signal, an optical signal, a radio signal, or a non-transitory computer-readable storage medium.

Any or all of the features and functions described above can be combined with each other, except to the extent it may be otherwise stated above or to the extent that any such examples may be incompatible by virtue of their function or structure, as will be apparent to persons of ordinary skill in the art. Unless contrary to physical possibility, it is envisioned that (i) the methods/steps described herein may be performed in any sequence and/or in any combination, and (ii) the components of respective examples may be combined in any manner.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

Conditional language, such as, among others, “can,” “could,” “might,” or “may,” unless specifically stated otherwise, or otherwise understood within the context as used, is generally intended to convey that certain cases include, while other examples do not include, certain features, elements and/or steps. Thus, such conditional language is not generally intended to imply that features, elements and/or steps are in any way required for one or more examples or that one or more examples necessarily include logic for deciding, with or without user input or prompting, whether these features, elements and/or steps are included or are to be performed in any particular example. Furthermore, use of “e.g.,” is to be interpreted as providing a non-limiting example and does not imply that two things are identical or necessarily equate to each other.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number, respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Conjunctive language such as the phrase “at least one of X, Y and Z,” unless specifically stated otherwise, is understood with the context as used in general to convey that an item, term, etc. may be either X, Y or Z, or any combination thereof. Thus, such conjunctive language is not generally intended to imply that certain cases require at least one of X, at least one of Y and at least one of Z to each be present. Further, use of the phrase “at least one of X, Y or Z” as used in general is to convey that an item, term, etc. may be either X, Y or Z, or any combination thereof.

In some cases, certain operations, acts, events, or functions of any of the algorithms described herein can be performed in a different sequence, can be added, merged, or left out altogether (e.g., not all are necessary for the practice of the algorithms). In certain cases, operations, acts, functions, or events can be performed concurrently, e.g., through multi-threaded processing, interrupt processing, or multiple processors or processor cores or on other parallel architectures, rather than sequentially.

Systems and modules described herein may comprise software, firmware, hardware, or any combination(s) of software, firmware, or hardware suitable for the purposes described. Software and other modules may reside and execute on servers, workstations, personal computers, computerized tablets, PDAs, and other computing devices suitable for the purposes described herein. Software and other modules may be accessible via local computer memory, via a network, via a browser, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, interactive voice response, command line interfaces, and other suitable interfaces.

Further, processing of the various components of the illustrated systems can be distributed across multiple machines, networks, and other computing resources. Two or more components of a system can be combined into fewer components. Various components of the illustrated systems can be implemented in one or more virtual machines or an isolated execution environment, rather than in dedicated computer hardware systems and/or computing devices. Likewise, the data repositories shown can represent physical and/or logical data storage, including, e.g., storage area networks or other distributed storage systems. Moreover, in some cases the connections between the components shown represent possible paths of data flow, rather than actual connections between hardware. While some examples of possible connections are shown, any of the subset of the components shown can communicate with any other subset of components in various implementations.

Embodiments are also described above with reference to flow chart illustrations and/or block diagrams of methods, apparatus (systems) and computer program products. Each block of the flow chart illustrations and/or block diagrams, and combinations of blocks in the flow chart illustrations and/or block diagrams, may be implemented by computer program instructions. Such instructions may be provided to a processor of a general purpose computer, special purpose computer, specially-equipped computer (e.g., comprising a high-performance database server, a graphics subsystem, etc.) or other programmable data processing apparatus to produce a machine, such that the instructions, which execute via the processor(s) of the computer or other programmable data processing apparatus, create means for implementing the acts specified in the flow chart and/or block diagram block or blocks. These computer program instructions may also be stored in a non-transitory computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded to a computing device or other programmable data processing apparatus to cause operations to be performed on the computing device or other programmable apparatus to produce a computer implemented process such that the instructions which execute on the computing device or other programmable apparatus provide steps for implementing the acts specified in the flow chart and/or block diagram block or blocks.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention. These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates other aspects of the invention in any number of claim forms. For example, while only one aspect of the invention is recited as a means-plus-function claim under 35 U.S.C sec. 112(f) (AIA), other aspects may likewise be embodied as a means-plus-function claim, or in other forms, such as being embodied in a computer-readable medium. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application, in either this application or in a continuing application.

1. A system, comprising:
a processor; and
a memory storing instructions that, when executed by the processor, cause the system to:
obtain a plurality of code files;
automatically parse the plurality of code files to identify dependencies in association with the plurality of code files;
based on the identified dependencies, generate a dependency graph that represents the identified dependencies associated with the plurality of code files;
analyze the dependency graph to generate a dependency-based output that indicates analysis associated with the identified dependencies associated with the plurality of code files; and
provide, for display, the dependency-based output.

2. The system of claim 1, wherein parsing the plurality of code files comprises:
generating an abstract syntax tree for each of the plurality of code files; and
analyzing the abstract syntax trees to identify import statements and function calls.

3. The system of claim 1, wherein generating the dependency graph comprises:
creating nodes representing at least a portion of each of the plurality of code files; and
establishing edges between the nodes based on the identified dependencies.

4. The system of claim 1, wherein the dependency graph comprises a tree structure with a root node corresponding to a main code file and child nodes corresponding to dependent code files.

5. The system of claim 1, wherein the dependency-based output comprises a dependency matrix generated by:
creating rows corresponding to different views or components of a software application; and
creating columns corresponding to different code dependencies, wherein each cell in the matrix indicates whether a particular view or component depends on a particular code file.

6. The system of claim 5, wherein the instructions further cause the system to generate a migration roadmap by:
identifying views or components with fewer dependencies based on the dependency matrix; and
prioritizing migration of the identified views or components with fewer dependencies.

7. The system of claim 1, wherein the instructions further cause the system to:
identify an orphan code file in the dependency graph that has no incoming dependency or outgoing dependency; and
remove the identified orphan code file from a codebase to improve system performance.

8. The system of claim 1, wherein an identified dependency is represented using an incoming dependency or an outgoing dependency.

9. The system of claim 1, wherein the instructions further cause the system to:
automatically adjust a codebase associated with the plurality of files based on the dependency-based output.

10. A method comprising:
obtaining a plurality of code files;
automatically parsing the plurality of code files to identify dependencies in association with the plurality of code files;
based on the identified dependencies, generating a dependency graph that represents the identified dependencies associated with the plurality of code files;
analyzing the dependency graph to generate a dependency-based output that indicates analysis associated with the identified dependencies associated with the plurality of code files; and
providing, for display, the dependency-based output.

11. The method of claim 10, wherein parsing the plurality of code files comprises:
generating an abstract syntax tree for each of the plurality of code files; and
analyzing the abstract syntax trees to identify import statements and function calls.

12. The method of claim 10, wherein generating the dependency graph comprises:
creating nodes representing at least a portion of each of the plurality of code files; and
establishing edges between the nodes based on the identified dependencies.

13. The method of claim 10, wherein the dependency graph comprises a tree structure with a root node corresponding to a main code file and child nodes corresponding to dependent code files.

14. The method of claim 10, wherein the dependency-based output comprises a dependency matrix generated by:
creating rows corresponding to different views or components of a software application; and
creating columns corresponding to different code dependencies, wherein each cell in the matrix indicates whether a particular view or component depends on a particular code file.

15. A non-transitory computer-readable medium storing instructions that, when executed by a processor, cause the processor to perform operations comprising:
obtaining a plurality of code files;
automatically parsing the plurality of code files to identify dependencies in association with the plurality of code files;
based on the identified dependencies, generating a dependency graph that represents the identified dependencies associated with the plurality of code files;
analyzing the dependency graph to generate a dependency-based output that indicates analysis associated with the identified dependencies associated with the plurality of code files; and
providing, for display, the dependency-based output.

16. The non-transitory computer-readable medium of claim 15, wherein the instructions further cause the processor to:
identify an orphan code file in the dependency graph that has no incoming dependency or outgoing dependency; and
remove the identified orphan code file from a codebase to improve system performance.

17. The non-transitory computer-readable medium of claim 15, wherein an identified dependency is represented using an incoming dependency or an outgoing dependency.

18. The non-transitory computer-readable medium of claim 15, wherein the instructions further cause the processor to:
automatically adjust a codebase associated with the plurality of files based on the dependency-based output.

19. The non-transitory computer-readable medium of claim 15, wherein the dependency-based output comprises a dependency matrix generated by:
creating rows corresponding to different views or components of a software application; and
creating columns corresponding to different code dependencies, wherein each cell in the matrix indicates whether a particular view or component depends on a particular code file.

20. The non-transitory computer-readable medium of claim 19, wherein the instructions further cause the processor to:
generate a migration roadmap by:
identify views or components with fewer dependencies based on the dependency matrix; and
prioritize migration of the identified views or components with fewer dependencies.
